(19) United States
(12) Patent Application Publication
(10) Pub. No.: US 2024/0116421 A1
(43) Pub. Date: Apr. 11, 2024

(54) MODULE SUPPORT ARRANGEMENT

(71) Applicant: Faurecia Autositze GmbH, Hannover (DE)

(72) Inventors: Piotr Ceglarek, Katowice (PL); Tomasz Stasinski, Dzierzoniow (PL); Tomasz Galanciak, Skierniewice (PL)

(73) Assignee: Faurecia Autositze GmbH, Hannover (DE)

(21) Appl. No.: 18/480,549

(22) Filed: Oct. 4, 2023

(30) Foreign Application Priority Data
Oct. 7, 2022 (DE) 102022125925.0

(51) Int. Cl. B60N 2/90

(52) U.S. Cl. CPC B60N 2/914

(57) ABSTRACT

A module carrier arrangement for attachment to the seat structure of a motor vehicle seat and for securing pneumatic components or non-pneumatic components has a module carrier with a front side and a rear side opposite the front side. Optionally, the module carrier arrangement has at least one further component, wherein air ducts and/or air duct portions are integrated in the module carrier and/or in the at least one further component.

### CROSS REFERENCE TO RELATED APPLICATIONS

This application claims priority on and the benefit of German Patent Application No. 10 2022 125925.0 having a filing date of 7 Oct. 2022.

### BACKGROUND OF THE INVENTION

### Technical Field

The invention relates to a module support or carrier arrangement.

### Prior Art

Such module carrier arrangements, such as those known from EP 3845415 A1, are typically attached to a vehicle seat structure and are designed to have certain functional components, such as fluid actuators, valve blocks or pumps, fastened thereto. In addition, the module carrier arrangements are also used for fastening the corresponding conduits for transporting air to the individual components. As a rule, such module carriers are found in vehicle seats behind the seat upholstery of the backrest or seat part.

In the known systems, the functional components usually have to be attached individually to the module carrier. This requires fastenings for conduits, valve blocks, pumps, etc. The number of components required for complete mounting, and thus the number of components required, is relatively high with this approach.

### BRIEF SUMMARY OF THE INVENTION

The object of the present invention is therefore to provide a module carrier arrangement in which the required number of components is reduced compared to the prior art.

This object is solved by a module carrier arrangement for attachment to the seat structure of a motor vehicle seat and for fixing pneumatic components or non-pneumatic components, having a module carrier with a front side and a rear side opposite the front side and optionally at least one further component, wherein in the module carrier and/or in the at least one further component i) air ducts and/or ii) air duct portions are integrated, and a vehicle seat having a seat frame structure and a module carrier arrangement as taught herein suspended therefrom via a suspension. Advantageous embodiments can be found in the subclaims.

The present invention reduces the number of components required by having parts of the conduit system already integrated into the module carrier arrangement or the carrier material thereof. Thus, according to the invention, the fluid lines are no longer designed as hoses or the like, but are already integrated as air ducts or at least air duct portions in the carrier material of the module carrier arrangement. To close any channels that may still be open, all that is then required is another component, e.g., a cover. This eliminates the need for complex installation of fluid hoses and greatly reduces the number of components.

The module carrier arrangement according to the invention, which is used for attachment to the seat structure of a motor vehicle seat and for fixing pneumatic components or non-pneumatic components, has a module carrier with a front side and a rear side opposite the front side. Optionally, the module carrier arrangement has at least one further component. Integrated in the module carrier and/or in the at least one further component are i) air ducts and/or ii) air duct portions. The latter can be arranged recessed—preferably with respect to the rear side and/or with respect to the front side. Thus, in the case of alternative i), complete air ducts may be integrated.

Preferably, in the case of alternative ii), air duct portions, preferably recessed, are integrated in such a manner that each of the air duct portions comprises open longitudinal sides, wherein the module carrier (1) or the at least one further component serves as a cover which closes the open longitudinal sides of the air duct portions in such a manner that air ducts are created as a result. Open longitudinal sides are created in this case, for example, by the fact that grooves which are U-shaped in cross section only and are open to one side, the longitudinal side, are introduced into the module carrier. Preferably, in the case of existing air duct portions with open longitudinal sides, a cover is further provided which closes the open longitudinal sides of the air duct portions in such a manner that air ducts are thereby formed. Air ducts created in this manner or existing in any case are then designed in such a manner that air can preferably only enter or exit at the ends located in the direction of flow. Branches or openings between the ends are conceivable in principle. Separate attachment of air ducts or hoses can be avoided in this manner, which saves assembly effort and additional components, since the cover can cover a plurality of air duct portions simultaneously. The cover can also be part of a housing designed to receive another pneumatic component, for example a valve block or pump. In this manner, integration can be increased even further.

Preferably, the module carrier has a recess in which the integrated air duct portions are arranged. When the further component, e.g., in the form of a cover, is then inserted into the recess, which is preferably done in a form-fitting manner, the further component is automatically correctly positioned to close the corresponding open longitudinal sides, which further simplifies the mounting. A further component or cover may well itself be designed in several parts.

The material of the module carrier and/or the further component can be designed in different manners. According to preferred embodiments, it may be provided, inter alia, that the material comprises or consists of a plastics material, a film material or a felt material. In this case, the carrier material or module carrier arrangement can be or have a part formed by injection molding or thermoforming.

Other parts can also be integrated into the module carrier arrangement according to the invention. Preferably, for example, the module carrier may comprise integrated attachment portions attaching or housing pneumatic components and/or non-pneumatic components. For example, the pneumatic components may be selected from the following group: pump, valve block, fluid actuator. For example, a non-pneumatic component may be selected from the group consisting of: vibration system component, ventilation system component, electrical component, wire harness, connector, cover. The optional further component can be a pneumatic or non-pneumatic component.

According to the invention, portions can be provided on the module carrier to which hose lines or fluid actuators can be fastened.

Finally, the invention relates to a vehicle seat which has a seat frame structure and a module carrier arrangement described above suspended therefrom via a suspension.

### BRIEF DESCRIPTION OF THE DRAWINGS

The invention is explained in more detail below with reference to FIGS. 1-10.

FIG. 1 shows a schematic, side exploded view of an exemplary embodiment of a module carrier arrangement according to the invention in sectional view.

FIG. 2 shows the embodiment shown in FIG. 1 as a simple sectional view.

FIG. 3 shows a top view of the front of an example of a module carrier according to the invention as part of a module carrier arrangement.

FIG. 4 shows a perspective view of the front of the module carrier shown in FIG. 3.

FIG. 5 shows a magnified view of detail D from FIG. 4.

FIG. 6 shows a top view of the rear of the module carrier of FIG. 3.

FIG. 7 shows a module carrier arrangement according to the invention with the module carrier shown in FIG. 3 and with the cover attached to it.

FIG. 8 shows a perspective view of the front of the module carrier shown in FIG. 7.

FIG. 9 shows a magnified view of detail D from FIG. 8.

FIG. 10 shows the top view shown in FIG. 7 with additionally installed fluid actuators.

### DETAILED DESCRIPTION OF PREFERRED EMBODIMENTS

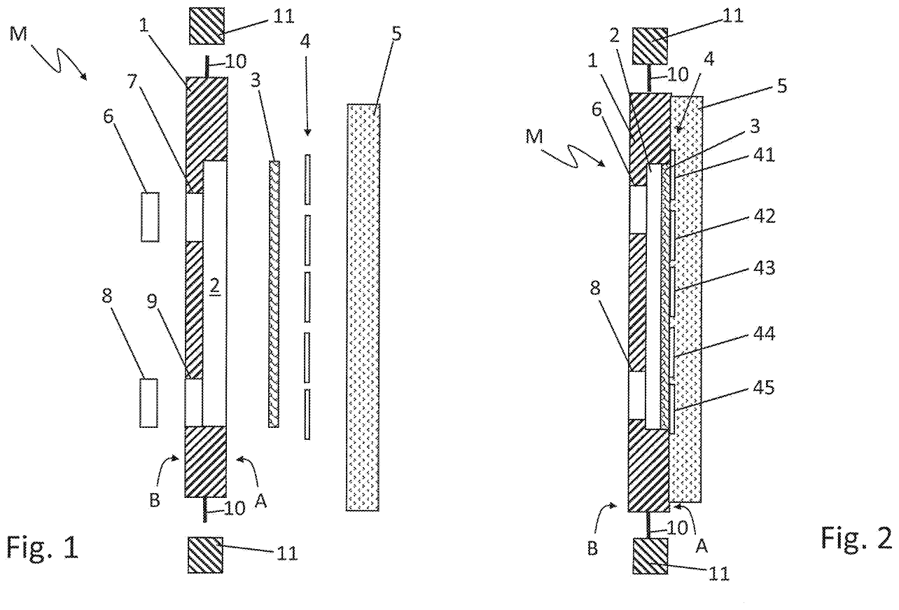

FIGS. 1 and 2 show a sectional view showing an exemplary structure of a module carrier arrangement M according to the invention. FIG. 1 shows this in exploded view, FIG. 2 in composite representation.

The module carrier 1 has a front side A and a rear side B. Generally, the front A will face in the direction of travel of a vehicle seat equipped with the module carrier arrangement M according to the invention. Of such a vehicle seat, only the seat frame structure 11 and a seat cushion 5 are indicated here. The module carrier 1 can then be attached to the seat frame structure 11 via a suspension 10, which in the simplest case is metal wires or the like.

The module carrier 1 is preferably produced from a material which preferably contains plastics, a film or felt. In a preferred embodiment, a non-mandatory recess 2 is arranged in the module carrier 1, preferably a recess accessible from the front side A. The module carrier 1 has, preferably in the base of the recess, air duct portions or even complete air ducts not shown in detail here, which are part of a pneumatic system installed on the module carrier 1 as part of the module carrier arrangement M according to the invention. In addition to a conduit system formed by the air ducts, the pneumatic system may have other components, for example pneumatic components such as a valve block 6 and/or a pump 8. Corresponding receptacles 7 or 9 for the valve block 6 or for the pump 8, respectively, can be provided on the module carrier 1. These receptacles 7, 9 form attachment portions with which the pneumatic components can be fastened to the module carrier 1.

In the example shown, the module carrier arrangement M further comprises a further component, in this case in the form of a cover 3, which can be attached to the module carrier 1—preferably in a form-fitting manner—if a recess 2 is present, in order to cover air duct portions present there and prevent the air flowing through them from escaping to the outside. If complete air ducts are already present in module carrier 1, such a cover is unnecessary. However, it is also possible, alternatively or supplementarily, to integrate corresponding air duct portions in said further component 3. The complete air ducts are then also created by joining module carrier 1 and further component 3. Reference sign 4 or 41-45 denotes fluid actuators, which are preferably fluid-fillable bladders, with the aid of which a seat adjustment function or also a massage function can be realized. These fluid actuators 4, 41-45 also form components of the pneumatic system and can be connected to air ducts present in the module carrier 1 and/or the further component 3 and thereby be supplied with air. A seat cushion 5 can then be placed on the front A above the fluid actuators 4, 41-45.

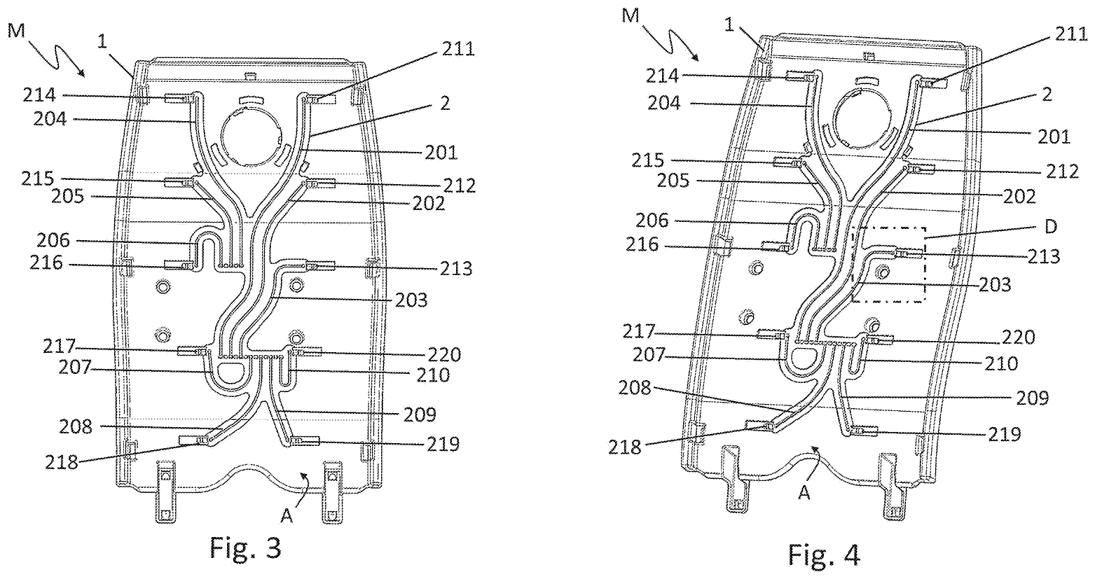

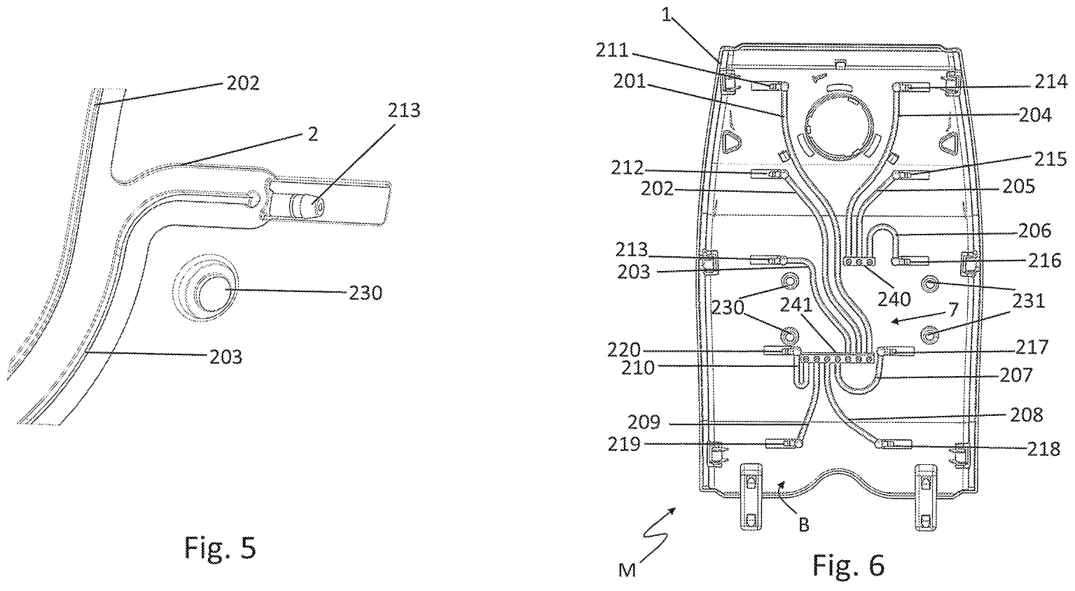

A top view of the front side A of the module carrier arrangement M according to the invention, more precisely of the module carrier 1 thereof, is shown in FIG. 3. FIG. 4 shows a similar view in slight perspective representation. The recess 2 and air duct portions 201-210 recessed therein relative to the recess 2 can be seen. These air duct portions 201-210 have corresponding ports 211-220 at one end thereof, which are used to connect the fluid actuators described above to the air duct system. Either the fluid actuators can be connected to these ports 211-220 directly or, for example, via a short hose. One such representation is shown in FIG. 5. There, the connection 213 can preferably be designed as a hose nozzle onto which a short hose can be attached.

As can be seen from the rear view of the module carrier 1 in FIG. 6, attachment portions 230, 231 are arranged in the area 7 to fasten a corresponding valve block to the module carrier 1. In the simplest case, these can be corresponding drilled holes or threaded holes where the valve block can be screwed or otherwise connected to the module carrier 1. Accordingly, the illustrated air duct portions 201-210 terminate at connections 240, 241 which are then fluidically connected to a valve block at a suitable location when the valve block is fastened. This situation is particularly represented in FIG. 11. The valve block 6 can be seen there, wherein the valve block is connected to the connections 240 and 241, while being mechanically fixed to the attachment portions 230 and 231.

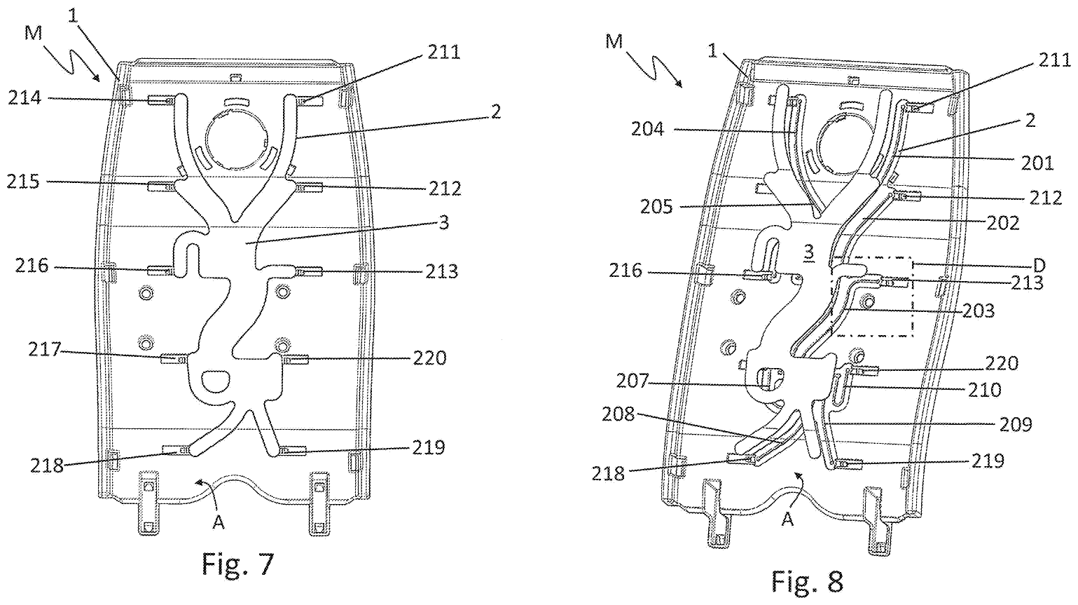

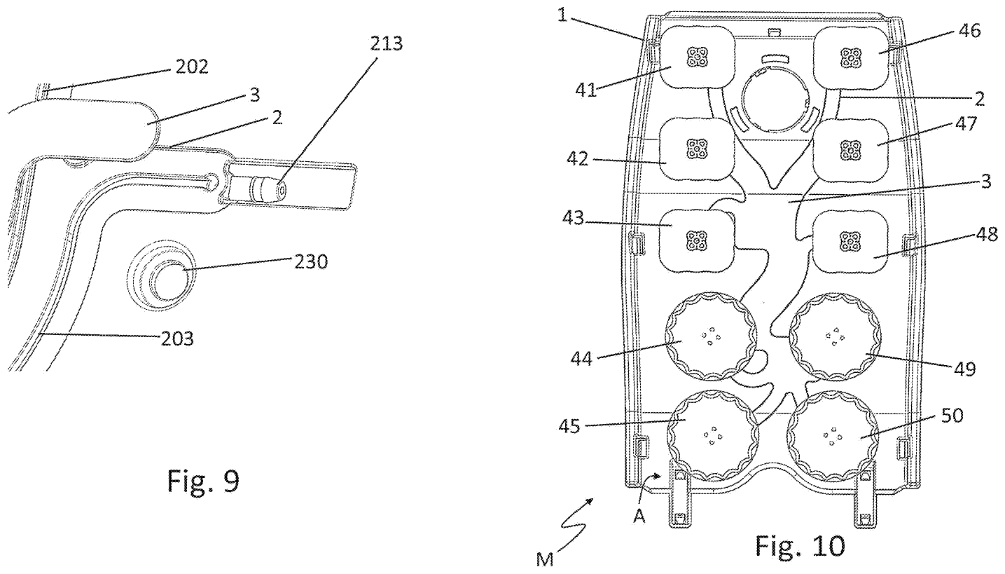

If, as in the example shown here, there are air duct portions on the module carrier or in the optional recess 2 of the module carrier or in the further component 3 described above, which duct portions are open at least to one longitudinal side, here preferably to the front side A, these must be covered by means of the further component 3 (or by the module carrier 1). This situation is shown in FIG. 7 in plan view, in FIG. 8 in perspective view and in FIG. 9 as an enlarged view of detail D from FIG. 8. The further component 3, shown here as a cover by way of example, thus covers the open longitudinal sides of the air duct portions and thus ensures that these air duct portions become air ducts at which the air can normally enter or exit only at the connections 211-220 or at the corresponding opposite ends.

FIG. 10 shows how fluid actuators 41-50 are fastened to ports 211-220.

The module carrier arrangement according to the invention thus allows components of a pneumatic system to be at least partially integrated in a module carrier. This means that components can be saved, since at least parts of pneumatic components are formed by the module carrier itself or the material of the module carrier.

What is claimed is:

1. A module carrier arrangement (M) for attachment to the seat structure of a motor vehicle seat and for fixing pneumatic components (6, 8; 41-50) or non-pneumatic components, having a module carrier (1) with a front side (A) and a rear side (B) opposite the front side (A) and optionally at least one further component (3), wherein in the module carrier (1) and/or in the at least one further component (3)
i) air ducts and/or
ii) air duct portions (201-210) are integrated.

2. The module carrier arrangement (M) according to claim 1, wherein, in the case of alternative ii), the air duct portions (201-210) are integrated, preferably recessed, in such a manner that each of the air duct portions (201-210) comprises open longitudinal sides, wherein the module carrier (1) or the at least one further component (3) serves as a cover (3) which closes the open longitudinal sides of the air duct portions (201-210) in such a manner that air ducts are formed thereby.

3. The module carrier arrangement (M) according to claim 1, wherein the module carrier (1) has a recess (2) in which the integrated air duct portions (201-210) are arranged, and wherein the at least one further component (3) is inserted into the recess (2).

4. The module carrier arrangement (M) according to claim 1, wherein the module carrier (1) and/or the at least one further component has a material which comprises or consists of a plastics material, film material or a felt material.

5. The module carrier arrangement (M) according to claim 1, wherein the module carrier (1) and/or the at least one further component is an injection-molded part or a part formed by thermoforming.

6. The module carrier arrangement (M) according to claim 1, further comprising integrated attachment portions (230, 231; 211-219) for attaching or accommodating pneumatic components (6, 8; 41-50) or non-pneumatic components.

7. The module carrier arrangement (M) according to claim 1, wherein the at least one non-pneumatic component is selected from the group consisting of a vibration system component, a ventilation system component, an electrical component, a wire harness, a connector, and a cover.

8. The module carrier arrangement (M) according to claim 1, wherein the pneumatic components (6, 8; 41-50) are selected from the following group consisting of a pump (8), a valve block (6), and a fluid actuator (41-50).

9. The module carrier arrangement (M) according to claim 1, wherein the at least one further component (3) is attached to the module carrier (1) by laser welding, high-frequency welding, vibration welding, adhesive bonding, or clipping.

10. A vehicle seat having a seat frame structure and a module carrier arrangement (M) suspended therefrom via a suspension (10), wherein the module carrier arrangement (M) is for fixing pneumatic components (6, 8; 41-50) or non-pneumatic components therefrom, the module carrier arrangement (M) having a module carrier (1) with a front side (A) and a rear side (B) opposite the front side (A) and optionally at least one further component (3), wherein in the module carrier (1) and/or in the at least one further component (3)
i) air ducts and/or
ii) air duct portions (201-210) are integrated.
